(19) United States
(12) Patent Application Publication
(10) Pub. No.: US 2012/0019890 A1
(43) Pub. Date: Jan. 26, 2012

(54) ELECTROCHROMIC UNIT AND DISPLAY DEVICE USING THE SAME

(75) Inventors: YU-CHOU YEH, TAOYUAN COUNTY (TW); CHAO-YI WANG, TAOYUAN COUNTY (TW); TSUNG-HER YEH, TAIPEI COUNTY (TW)

(73) Assignee: J TOUCH CORPORATION, TAOYUAN COUNTY (TW)

(21) Appl. No.: 12/951,638

(22) Filed: Nov. 22, 2010

(30) Foreign Application Priority Data
Jul. 22, 2010 (TW) 099124255
Sep. 17, 2010 (CN) 201010287041.5

(51) Int. Cl. G02F 1/153; B82Y 99/00; B82B 1/00

(52) U.S. Cl. 359/273; 359/265; 359/267; 977/742; 977/952

(57) ABSTRACT

In an electrochromic unit and a display device using the electrochromic unit, the electrochromic unit includes a first transparent substrate, a second transparent substrate, and a transparent conductive element and an electrochromic layer formed between the substrates, and electrons are used for changing the valence of ions of an electrochromic material, such that a reduction is resulted by supplying electrons and an oxidation is resulted by removing electrons to change colors, and the electrochromic coloration rate is quicker and more uniform and the driving voltage is smaller than those of the present existing electrochromic materials. A coloration/decoloration electrochromism can be achieved in a different way than the method of applying the dual addition and dual removal of ions and electrons in organic/inorganic electrochromic material.

### CROSS-REFERENCE TO RELATED APPLICATIONS

This non-provisional application claims priority under 35 U.S.C. §119(a) on Patent Application No(s). 099124255 filed in Taiwan, R.O.C. on Jul. 22, 2010, the entire contents of which are hereby incorporated by reference.

This non-provisional application claims priority under 35 U.S.C. §119(a) on Patent Application No(s). 201010287041.5 filed in China on Sep. 17, 2010, the entire contents of which are hereby incorporated by reference.

### BACKGROUND OF THE INVENTION

1. Field of the Invention

The present invention relates to a display device, and more particularly to an electrochromic unit and a display device using the electrochromic unit.

2. Description of the Related Art

The principle of present well-known stereo image display technologies adopts a binocular disparity for receiving different images from both left and right eyes of a user respectively, and finally the user's brain merges the images into a stereo image. In naked-eye stereo display technologies, there are two main types of structures, respectively: lenticular lens and barrier.

However, present existing stereo image display devices can display 3D images only, but they cannot be switched to display 2D images and 3D images primarily because images passed through the lenticular lens or barrier combined with a general display device will be divided into a left-eye image and a right-eye image, unless an external 3D image display module is used for attaching into the display device, and the external 3D image display module can be removed from the device when there is no need of displaying 3D images. The practical use of this method requires a precise alignment to avoid a decreased resolution and an oblique condition. Therefore, some manufacturers developed a stereo image display device capable of switching the display of 3D images or 2D images.

As to the present existing technologies, a specific light transmitting matter in a transparent form is used for displaying 2D images, and the specific light transmitting matter will produce a plurality of light-shading grids to form a barrier when a display device is switched to display 3D images, and the specific light transmitting matter is a material related to an electrochromism (EC) which refers to the phenomenon displayed by some electrochromic materials of reversibly changing color caused by a light absorption or desorption under the effect of a current or an electric field. The electrochromic materials can be divided into inorganic electrochromic materials and organic electrochromic material that must have the following properties in practical applications: (1) good electrochemical redox reversibility, (2) quick color change response time, (3) reversible color change, (4) high sensitivity of color change, (5) long cycle life, (6) certain memory storage function, and (7) good chemical stability.

At present, electrochromic patented technologies adopt oxides or hydroxides of transition elements or their derivatives to produce inorganic solid-state films or mix their organic compounds/electrolyte material to produce composite materials, and provide electrons or an ion source (an electrolyte or a second electrochromic material) to allow ions to enter into the crystal lattice to achieve an color change effect of the electrochromic materials such as WO₃, Ni(OH)₂, and Prussian blue. Besides the aforementioned electrochromic materials, inorganic electrochromic materials have a stable characteristic, and whose light absorption change is caused by dual addition and dual removal of ions and electrons. The organic electrochromic materials include polyaniline, vioiogen and rare-earth phthalocyanine and come with a variety of colors. In other words, the organic material is produce by oxidation and reduction. Although the organic material provides a faster reaction, it has issues of environment protection and toxicity.

Some patents related to a 3D image display device having a function of switching the display to 3D image or 2D image are listed below:

As disclosed in R.O.C. Pat. No. M368088 entitled “Integrated electrochromic 2D/3D display device, R.O.C. Pat. No. M371902 entitled “Display device for switching 2D image/3D image display screen”, R.O.C. Pat. No. I296723 entitled “Color filter used for 3D image LCD panel manufacturing method thereof”, and U.S. Pat. Publicarion No. 2006087499 entitled “Autostereoscopic 3D display device and fabrication method thereof”, electrochromic materials are used as a parallax barrier device for displaying 3D images, but both patents of M368088 and M371902 have a common drawback of lacking a necessary electrolyte layer required by electrochromic devices, since ions are not supplied to the electrolyte layer of the electrochromic layer, and the electrochromic device cannot produce the reversible oxidation or reduction to complete the change of coloration or decoloration, so that the aforementioned patents are not feasible in practical applications, or the coloration and decoloration rate will become extremely slow. In addition, the transparent electrode layer and electrochromic material layer of the parallax barrier device are grid patterned, and whose manufacturing process requires a precise alignment for coating, spluttering or etching each laminated layer, and thus the manufacturing process is very complicated, and all laminated layers are grid patterned, so that a hollow area is formed between one grid and the other, and the overall penetration, refraction and reflection of the light will be affected. Even for the general 2D display, the video display quality of the display device will be affected to cause problems related to color difference and uneven brightness. In addition, the structural strength of the display device is low, and the using life is short. The patent I296723 disclosed an embedded liquid display device (LCD) formed in a structure of a color filter plate. A greater driving voltage is required in conventional electrochromic materials and chromic mechanisms adopted in the electrochromic layer of the aforementioned patents, which causes a defect of the material easily, and results in a shorter using life.

### SUMMARY OF THE INVENTION

In view of the aforementioned shortcomings, the inventor of the present invention based on years of experience in the related industry to conduct extensive researches and experiments, and finally developed an electrochromic unit and a display device using the electrochromic unit in accordance with the present invention.

An objective of the present invention is to provide an electrochromic unit with a reduced thickness and a simplified manufacturing process.

Another objective of the present invention is to provide an electrochromic unit without requiring additional electrolytes.

Another objective of the present invention is to provide an electrochromic unit with a quick coloration/decoloration, a long cycle life, and a small driving voltage.

Another objective of the present invention is to provide an electrochromic unit having the advantages but not the disadvantages of the organic/inorganic electrochromic materials.

To achieve the foregoing objectives, the present invention provides an electrochromic unit that using electrons of an electrochromic material to change the valence of ions of the electrochromic material for a change of color, and the electrochromic material is a transition element of a copper subgroup (IB), a zinc subgroup (IIB), a scandium subgroup (IIIB), a titanium subgroup (IVB), a vanadium subgroup (VB), a chromium subgroup (VIB), a manganese subgroup (VIIB), an iron series (VIIIB), a platinum series (VIIIB of the fifth or sixth period), an alkali metal group (IA), an alkali earth metal group (IIA), an oxygen group (VIA), a nitrogen group (VA), a carbon group (VIA) and a boron group (IIIA) or an organic/inorganic derivative of an oxide, a sulfide, a chloride or a hydroxide of the above transition element dissolved in a solvent, and a conductive element supplies electrons to change the valence of ions of the electrochromic material for a color change. Particularly, the concept of supplying electrons for a reduction and removing electrons for an oxidation provides a faster and more uniform color change than the conventional electrochromic material as well as the advantages of a small driving voltage and a long lifespan. In the meantime, ultraviolet light (UV) can produce the same effects of providing electrons to change color. Electrochromic materials of this sort can be applied to in the areas of display devices, e-books, 2D/3D conversion devices, rearview mirrors and intelligent glass, or even mixed with a conductive polymer to form an electrochromic ink used together with a screen printing method.

To achieve the foregoing objectives, the present invention provides an electrochromic unit comprising a first transparent substrate, a second transparent substrate, an electrochromic layer formed between the transparent substrates, and a transparent conductive element installed on a surface of the first transparent substrate, a surface of the second transparent substrate, or corresponding surfaces of both first transparent and second substrates, and electrons are supplied to the electrochromic layer by the transparent conductive element, such that the valence of ions of the electrochromic layer is changed for a color change.

When the electrochromic unit is used for masking a 3D image display device to drive the electrochromic layer to produce a light shield area of grids, the following three methods can be adopted. In the first method, an isolating unit such as a photoresist is used for separating the electrochromic layers, such that when the electrochromic layers produce a color change, the structure of the electrochromic layers is arranged in a strip shape. In the second method, the electrochromic layers are arranged with an interval apart into a plurality of strips by a screen printing method. In the third method, a plurality of transparent conductive elements is used as isolating units for separating the electrochromic layers, and high and low voltages are applied alternately to two adjacent transparent conductive elements, such that after the transparent conductive elements are electrically conducted, the electrochromic layers will produce a color change. All of the foregoing methods use the electrochromic layers to produce a light shield area of grids to form the barrier.

Therefore, a 3D image is divided into a left-eye image and right-eye image when the image display unit is switched from displaying 2D images to 3D images. Now, the transparent conductive elements are electrically conducted, such that the color of the electrochromic layers is changed from a transparent area into a dark light shield area according to the arrangement of the electrochromic units with an interval apart from each other. The electrochromic unit produces a plurality of light shield areas arranged with an interval apart and divides the 3D image into a left-eye image and a right-eye image by eliminating the portion of an overlapped image area in the light shield area, such that after our naked eyes receive the images, overlapped patterns will not be produced. In general, a lenticular lens or a barrier is added onto a display device for displaying 3D images, but the electrochromic unit and the display device using the electrochromic unit in accordance with the present invention can divide the image into the 3D left-eye image and the 3D right-eye image directly by the display unit.

### BRIEF DESCRIPTION OF THE DRAWINGS

FIG. 1 is an exploded view of a first preferred embodiment of the present invention;

FIG. 2 is a first schematic view of a transparent conductive element in accordance with a first preferred embodiment of the present invention;

FIG. 3 is a second schematic view of a transparent conductive element in accordance with a first preferred embodiment of the present invention;

FIG. 4 is an exploded view of a second preferred embodiment of the present invention;

FIG. 5 is a first schematic view of actions in accordance with a second preferred embodiment of the present invention;

FIG. 6 is a second schematic view of actions in accordance with a second preferred embodiment of the present invention;

FIG. 7 is a first schematic view of a transparent conductive element in accordance with a second preferred embodiment of the present invention;

FIG. 8 is a second schematic view of a transparent conductive element in accordance with a second preferred embodiment of the present invention;

FIG. 9 is a third schematic view of a transparent conductive element in accordance with a second preferred embodiment of the present invention;

FIG. 10 is a fourth schematic view of a transparent conductive element in accordance with a second preferred embodiment of the present invention;

FIG. 11 is a first schematic view of a transparent conductive element in accordance with a third preferred embodiment of the present invention;

FIG. 12 is a second schematic view of a transparent conductive element in accordance with a third preferred embodiment of the present invention;

FIG. 13 is a third schematic view of a transparent conductive element in accordance with a third preferred embodiment of the present invention;

FIG. 14 is a fourth schematic view of a transparent conductive element in accordance with a third preferred embodiment of the present invention;

FIG. 15 is a cross-sectional view of a fourth preferred embodiment of the present invention;

FIG. 16 is a top view of a transparent conductive element in accordance with a fourth preferred embodiment of the present invention;

FIG. 17 is a schematic view of a transparent conductive element in accordance with a fourth preferred embodiment of the present invention;

FIG. 18 is a cross-sectional view of a transparent conductive element in accordance with a fifth preferred embodiment of the present invention;

FIG. 19 is a top view of a transparent conductive element in accordance with a fifth preferred embodiment of the present invention;

FIG. 20 is a schematic view of a transparent conductive element in accordance with a fifth preferred embodiment of the present invention;

FIG. 21 is a cross-sectional view of a transparent conductive element in accordance with a sixth preferred embodiment of the present invention; and

FIG. 22 is a schematic view of a transparent conductive element in accordance with a sixth preferred embodiment of the present invention.

### DETAILED DESCRIPTION OF THE PREFERRED EMBODIMENTS

The technical characteristics and effects of the present invention will be apparent with the detailed description of preferred embodiment together with the illustration of related drawings as follows.

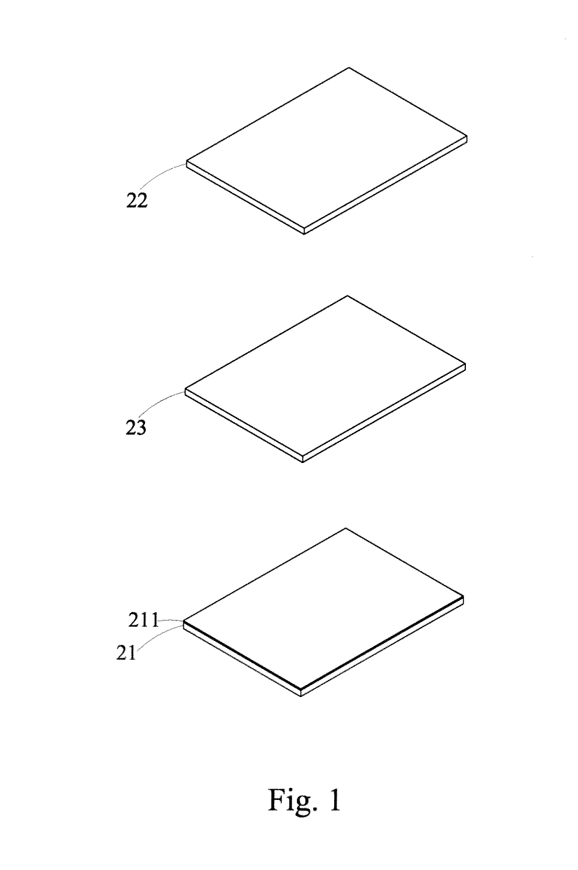

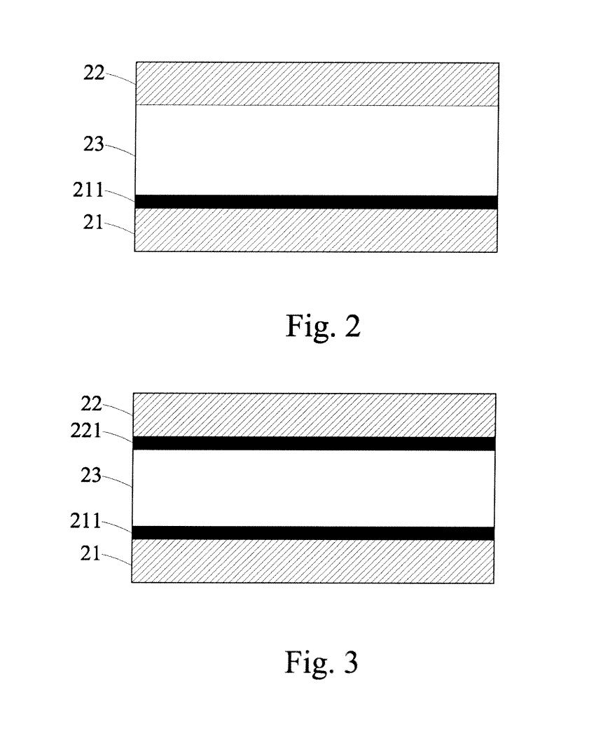

With reference to FIGS. 1 to 3 for an exploded view of an electrochromic unit 2 a first schematic view of a transparent conductive element and a second schematic view of a transparent conductive element in accordance with a first preferred embodiment of the present invention respectively, the electrochromic unit 2 comprises a first transparent substrate 21, a second transparent substrate 22, an electrochromic layer 23 formed between the first and the second transparent substrates 21, 22, and a first transparent conductive element 211, wherein the first transparent conductive element 211 can be installed on a surface of the first transparent substrate 21 (as shown in FIG. 1) or on a surface of the second transparent substrate 22 (as shown in FIG. 2), or the transparent conductive elements 211, 221 are installed on surfaces of the first transparent substrate 21 and the second transparent substrate 22 respectively (as shown in FIG. 3), such that the electrochromic layer 23 can change the valence of ions of its structure by a supply of electrons from the first transparent conductive element 211 for a color change.

Beside the conventional structure of having the electrochromic layer 23 included between upper and lower transparent conductive elements, a plurality of transparent conductive elements is preferably arranged with an interval apart from each other for providing voltages of different potentials alternately, if a single substrate has the plurality of transparent conductive element, such that a voltage difference exists between electrodes, and electrons can be provided for the color change of the electrochromic layer 23.

The first transparent substrate 21 and the second transparent substrate 22 are made of a plastic, polymer plastic or glass material, or a plastic polymer selected from the collection of resin, polyethylene terephthalate (PET), polycarbonate (PC), polyethylene) (PE), polyvinyl chloride (PVC), polypropylene (PP), polystyrene (PS), and polymethylmethacrylate (PMMA); and the first transparent conductive element 211 and the second transparent conductive element 221 are made of an impurity-doped oxide selected from the collection of indium tin oxide (ITO), indium zinc oxide (IZO), Al-doped ZnO (AZO), antimony tin oxide (ATO) or carbon nanotubes.

The electrochromic layer 23 is disposed between the first transparent substrate 21 and the second transparent substrate 22 and covered onto a surface of the first transparent conductive element 221, and the electrochromic layer 23 is made of a material comprising a transition element selected from the collection of a copper subgroup (IB), a zinc subgroup (IIB), a scandium subgroup (IIIB), a titanium subgroup (IVB), a vanadium subgroup (VB), a chromium subgroup (VIB), a manganese subgroup (VIIB), an iron series (VIIIB), a platinum series (VIIIB of the fifth or sixth period), an alkali metal group (IA), an alkali earth metal group (IIA), an oxygen group (VIA), a nitrogen group (VA), a carbon group (VIA), and a boron group (IIIA) or an organic/inorganic derivative prepared by dissolving an oxide, sulfide, chloride or hydroxide into a solvent, wherein the solvent is dimethyl sulfoxide (CH₃)₂SO, propylene carbonate (C₄H₆O₃) or water (H₂O). The conductive element supplies electrons to change the valence of ions of the electrochromic material for a color change. In particular, electrons are supplied to the valance of ions to produce a reduction and electrons are removed to produce an oxidation, so that the coloration speed is faster and more uniform than that of the conventional electrochromic material, and the driving voltage is smaller and the life span is longer. In the meantime, ultraviolet lights are provided for generating electrons to give the same coloration effect. The electrochromic materials of this sort can be applied in the areas of display devices, e-books, 2D/3D conversion devices, rearview mirrors and smart glass. The electrochromic layer can be mixed with an electrically conductive polymer to produce an electrochromic ink to be used together with a screen printing method.

Examples of colors of various groups mentioned above are listed and described below:

Halogen Group (VIIA):

Solid: I₂ purplish black; ICl dark red; IBr dark grey; IF₃ yellow; ICl₃ orange; I₂O₅ white; I₂O₄ yellow (ion crystals); I₄O₉ yellow (ion crystals).

Oxygen Group (VIA):

Solid: S light yellow; Se grey, brown; Te colorless metal luster; Na₂S,(NH₄)₂S, K₂S,BaS white, soluble; ZnS white↓; MnS red flesh↓; FeS black↓; PbS black↓; CdS yellow↓; Sb₂S₃ orange red↓; SnS brown↓; HgS black (precipitate), red (cinnabar red); Ag₂S black↓; CuS black↓; Na₂S₂O₃ white; Na₂S₂O₄ white; SeO₂ white, volatile; SeBr₂ red; SeBr₄ yellow; TeO₂ white heated to become yellow; H₂TeO₃ white; TcBr_{z} brown; TeBr₄ orange; TeI₄ grayish black; PoO₂ low-temperature yellow (face-centered cube), high-temperature red (tetrahedron); SO₃ colorless; SeO₃ colorless easily soluble in water; TeO₃ orange; H₆TeO₆ colorless.

Nitrogen Group (VA):

Solid: ammonium salt colorless crystal; nitrified metal white; N₂O₃ blue (low-temperature); N₂O₅ white; P white, red, black; P₂O₃ white; P₂O₅ white; PBr₃ yellow; PI₃ red; PCl₅ colorless; P₄Sx yellow; P₂S₃ grayish yellow; P₂S₅ light yellow; H₄P₂O₇ colorless glass form; H₃PO₂ white; As grey; As₂O₃ white; As₂O₅ white; AsI₃ red; As₄S₄ red (arsenic disulfide); As₄S₆ yellow (arsenic trisulphide); As₂S₅ light yellow; Sb silver white; Sb(OH)₃ white↓; Sb₂O₃ white (antimony white pigment); Sb₂O₅ light yellow; SbX₃(X< >0 white; SbI₃ red; Sb₂S₃ orange red↓; Sb₂S₅ orange yellow; Bi silver white and slightly red; Bi₂O₃ light yellow; Bi₂O₅ reddish brown; BiF₃ grayish white; BiCl₃ white; BiBr₃ yellow; BiI₃ black↓; Bi₂S₃ brownish black.

Carbon Group (IVA):

Solid: C (corundum) colorless transparent; C (graphite) black color metal luster; Si grayish black color metal luster; Ge grayish white; Sn silver white; Pb dark grey; SiO₂ colorless transparent; H₂SiO₃ colorless transparent gel↓; Na₂SiF₆ white crystal; GeO black; GeO₂ white; SnO black; SnO₂ white; Sn(OH)₂ white↓; PbO yellow or yellowish red; Pb₂O₃ orange; Pb₃O₄ red; PbO₂ brown; CBr₄ light yellow; Cl₄ light red; GeI₂ orange; GeBr₂ yellow; GeF₄ white; GeBr₄ grayish white; GeI₄ yellow; SnF₂ white; SnCl₂ white; SnBr₂ light yellow; SnI₂ orange; SnF₄ white; SnBr₄ colorless; SnI₄ red; PbF₂ colorless ↓; PbCl₂ white↓; PbBr₂ white; PbI₂ gold yellow; PbF₄ colorless; GeS red; GeS₂ white; SnS brown↓; SnS₂ gold yellow (commonly called gold powder) ↓; PbS black↓; PbS₂ reddish brown; Pb(NO₃)₂ colorless; Pb(Ac)₂.3H₂O colorless crystal; PbSO₄ white↓; PbCO₃ white↓; Pb(OH)₂ white↓; Pb₃(CO₃)₂(OH)₂ lead white↓; PbCrO₄ white yellow↓.

Boron Group (IIIA):

Solid: B (with no fixed shape) brown powder; B (crystal) grayish black; Al silver white; Ga silver white (easily liquefied); In silver grey; Tl silver grey; B₂O₃ glass form; H₃BO₃ colorless sheet form; BN white; Na₂B₄O₇.10H₂O white crystal; Cu(BO₂)₂ blue↓; Ni(BO₂)₂ green 1; NaBO₂.Co(BO₂)₂ blue 1; NaBO₂4H₂O colorless crystal; non-aqueous NaBO₂ yellow crystal; Al2O3 white crystal; AIF3 colorless; AlCl3 white; AlBr₃ white; AlI₃ brown; Al(OH)₃ white↓; Ga₂O₃ white↓ Ga(OH)₃ white↓; GaBr₃ white; GaI₃ yellow; In₂O₃ yellow; InBr₃ white; InI₃ yellow; TlOH yellow; Tl₂O black; Tl₂O₃ brownish black; TlCl white↓; TlBr light yellow; TlI yellow↓ (similar to silver); TlBr₃ yellow; TlI₃ black.

Alkali Earth Metal (IIA):

Elementary substance: silver white

Flame color: Ca brick red; Sr magneta; Ba green.

Oxides: All oxides are white solids.

Hydroxides: White solids Be(OH)₂↓, Mg(OH)₂↓.

Salts: Most salts are colorless or white crystals; BeCl₂ light yellow; BaCrO₄ yellow↓; CaF₂ white↓.

Alkali Metal (IA):

Elementary substance: silver white

Flame color: Li red; Na yellow; K purple; Rb purplish red; Cs purplish red.

Oxide, Peroxide, Super Oxide, Ozonide: Li₂O white; Na₂O white; K₂O light yellow; Rb₂O white yellow; Cs₂O orange red; Na₂O₂ light yellow; KO₂ orange yellow; RbO₂ dark brown; CsO₂ dark yellow; KO₃ orange red; Hydroxide white; LiOH white

Hydroxide: white, LiOH white↓.

Salt: Most salts are colorless or white crystals and easily soluble in water.

Insoluble salt↓ (all are white crystals unless otherwise stated): LiFLi2CO₃Li₃PO₄ LiKFeIO₆Na[Sb(OH)₆]NaZn(UO₂)₃(Ac₉.6H₂O yellow green; M=K,Rb,Cs M₃[Co(NO₂)₆] white yellow; MBPh₄MClO₄M₂PtCl₆ light yellow; CsAuCl₄.

Copper Subgroup (IB):

Elementary substance: Cu purplish red or dark red; Ag silver white; Au gold yellow.

Copper compound: Flame color green; CuF red; CuCl white↓; CuBr yellow↓; CuI brownish yellow↓; CuCN white↓; Cu₂O dark red; Cu₂S black; CuF₂ white; CuCl₂ brownish yellow (yellowish green solution); CuBr₂ brown; Cu(CN)₂ brownish yellow; CuO black↓; CuS black↓; CuSO₄ colorless; CuSO₄.5H₂O blue; Cu(OH)₂ light blue↓; Cu(OH)₂.CuCO₃ green black; [Cu(H₂O)₄]²⁺ blue; [Cu(OH)₄]²⁻ bluish purple; [Cu(NH₃)₄]²⁺ dark blue; [CuCl₄]²⁻ yellow; [Cu(en)₂]²⁺ dark bluish purple; Cu₂[Fe(CN)₆] brown red; cuprous acetylide red↓.

Silver compound: AgOH white (decomposed at normal temperature); Ag₂O black; freshly made AgOH brownish yellow (mixed with Ag₂O); silver proteinate (AgNO₃ dropped on hands) black↓; AgF white; AgCl white↓; Ag bright yellow↓; AgI yellow↓ (gel); Ag₂S black↓; Ag₄[Fe(CN)₆] white↓; Ag₃[Fe(CN)₆] white↓; Ag⁺,[Ag(NH₃)₂]⁺,[Ag(S₂O₃)₂]³⁻,[Ag(CN)₂]⁻ colorless.

Gold compound: HAuCl₄.3H₂O white yellow crystal; KAuCl₄.1.5H₂O colorless sheet crystal; Au₂O₃ black; H[Au(NO₃)₄].3H₂O yellow crystal; AuBr grayish yellow↓; AuI lemon yellow↓.

Zinc Subgroup (IIB):

Elementary substance: All elementary substances are silver white, and the Hg precipitate in water solution is black.

Zinc compound: ZnO white (zinc white pigment) ↓; ZnI colorless: ZnS white↓; ZnCl₂ white crystal (highly soluble, water-soluble, acidic); K₃Zn₃[Fe(CN)₆] white; Zn₃[Fe(CN)₆] yellowish brown.

Cadmium compound: CdO brownish grey↓; CdI₂ yellow; CdS yellow (cadmium yellow pigment) ↓; HgCl₂ (mercury perchloride) white; HgNH₂Cl white↓; Hg₂Cl₂(mercurous chloride) white↓.

Mercury compound: HgO red (large crystal grain) or yellow (small crystal grain) ↓; HgI₂ red or yellow (slightly soluble); HgS black or red↓; Hg₂NI.H₂O red↓; Hg₂(NO₃)₂ colorless crystal.

ZnS phosphor: Ag blue; Cu yellowish green; Mn orange.

Titanium Subgroup (IVB):

Titanium compound: Ti³⁺ purplish red; [TiO(H₂O₂)₂]²⁺ orange yellow; H₂TiO₃ white ↓; TiO₂ white (titanium white pigment) or Mona red (rutile) ↓; (NH₄)TiCl₆ yellow crystal; [Ti(H₂O)₆]Cl₃ purple crystal; [Ti(H₂O)₅Cl]Cl₂.H₂O green crystal; TiCl₄ colorless smoke-generating liquid.

Zirconium, hafnium: MO₂, MCl₄ white.

Vanadium Subgroup (VB):

Vanadium compound: V²⁺ purple; V³⁺ green; VO²⁺ blue; V(OH)⁴⁻ yellow; VO4³⁻ yellow: VO black; V₂O₃ grayish black; V₂S₃ brownish black; VO₂ blue solid; VF₄ green solid; VCl₄ dark brown liquid; VBr₄ magneta liquid; V₂O₅ yellow or brick red; hydrate V₂O₅ brownish red; saturated V₂O₅ solution (slightly soluble) light yellow; [VO₂(O₂)₂]₃₋ yellow; [V(O₂)₃]³⁻ reddish brown.

Vanadium acid radical polycondensation: As the atomic number of vanadium reduces, the color changes from a light yellow to dark red˜light yellow.

Columbium, tantalum: omitted.

Chromium Subgroup (VIB):

Chromium compound: Cr²⁺ blue: Cr³⁺ purple; Cr₂O₇²⁻ orange red; CrO₄²⁻ yellow; Cr(OH)⁴⁻ bright green; Cr(OH)₃ grayish blue; Cr₂O₃ green; CrO₃ dark red needle shape; [CrO(O₂)₂]OEt₂ blue; CrO₂Cl₂ dark red liquid; Na₂Cr₂O₇,K₂CrO₇ orange red; Ag₂CrO₄ brick red; BaCrO₄ yellow↓; PbCrO₄ yellow↓.

Purplish red Cr₂(SO₄)₃.18H2O->Green Cr₂(SO₄)₃.6H₂O->Peach red Cr₂(SO₄)₃

Dark green [Cr(H₂O)₄Cl₂]Cl-cooling HCl->purple [Cr(H₂O)₆]Cl₃-ethylether HCl->light green [Cr(H₂O)₅Cl]Cl₂

[Cr(H₂O)₆]³⁺ purple; [Cr(H₂O)₄(NH₃)₂]³⁺ purplish red; [Cr(H₂O)₃(NH₃)₃]³⁺ light red; [Cr(H₂O)₂(NH₃)₄]³⁺ orange red; [Cr (NH₃)₅H₂O]³⁺ orange yellow; [Cr(NH₃)₆]³⁺ yellow.

Molybdenum, tungsten: MoO₃ white; brown MoCl₃; green MoCl₅; MoS₃ brown↓; (NH₄)₃[P(Mo₁₂O₄₀)].6H₂O yellow crystal form; WO₃ dark yellow; H₂WO₄xH₂O white gel.

Manganese Subgroup (VIIB):

Manganese compound: Mn²⁺ flesh red; Mn³⁺ purplish red; MnO₄²⁻ green; MnO₄⁻ purple; MnO³⁺ bright green; Mn(OH)₂ white.; MnO(OH)₂ brown↓; MnO₂ black↓; non-aqueous manganese salt (MnSO₄) white crystal; hexahydrate manganese salt (MnX₂.6H₂O, X=halogen. NO₃, ClO₄) pink; MnS.nH₂O flesh red↓; non-aqueous MnS dark green; MnCO₃ white↓; Mn₃(PO₄)₂ white↓; KMnO₄ purplish red; K₂MnO₄ green; K₂[MnF₆] gold yellow crystal; Mn₂O₇ brown oily liquid.

Technetium, Rhenium: omitted.

Iron Series (Group VIII of Fourth Period):

Iron compound: Fe light green; [Fe(H₂O)₆]³⁺ light purple; [Fe(OH)(H₂O)₅]²⁺ yellow; FeO₄²⁻ purplish red; FeO black; Fe₂O₃ dark red; Fe(OH)₂ white↓; Fe(OH)₃ brownish red↓; FeCl₃ or FeCl₂ crystal brown red blue; non-aqueous FeSO₄ white; FeSO₄7H₂O green; K₄[Fe(CN)₆] (yellow prussiate) yellow crystal; K₃[Fe(CN)₆] (red prussiate) red crystal; Fe₂[Fe(CN)₆] Prussian blue ↓; Fe[Fe(CN)₆] black↓; Fe(C₅H₅)₂ (ferrocene) orange yellow crystal; M₂Fe₆(SO₄)₄(OH)₁₂ (yellow ferrous sulfate, M=NH₄, Na, K) light yellow crystal; Fe(CO)₅ yellow liquid.

Cobalt compound: Co²⁺ pink; CoO grayish green; CO₃O₄ black; Co(OH)₃ brown↓; Co(OH)₂ pink↓; Co(CN)₂ red; K₄[Co(CN)₆] purple crystal; Co₂(CO)₈ yellow crystal; [Co(SCN)₆]⁴⁻ purple;

Cobalt chloride is dehydrated into pink CoCl₂.6H₂O-325K->purplish red CoCl. 2H₂O-313K->bluish purple CoCl₂.H₂O-393K->blue CoCl₂.

Nickel compound: Ni²⁺ bright green; [Ni(NH₃)₆]²⁺ purple; Ni(OH)₂ green ↓; Ni(OH)₃ black↓; non-aqueous Ni(II) salt yellow; Na₂[Ni(CN)₄] yellow; K₂[Ni(CN)₄] orange; Ni(CO)₄ colorless liquid.

Platinum Series Element (Group VIII of Fifth and Sixth Periods):

Os bluish grey volatile solid; Pd↓(aq) black; OsO₄ colorless special-odor gas; H₂PtCl₆ orange red crystal; Na₂PtCl₆ orange yellow crystal; M₂PtCl₆(M=K, Rb, Cs, NH₄) yellow↓.

For example, in ferrous chloride of an iron series (VIIIB), the solvent is dimethyl sulfoxide (DMSO). The ferrous chloride crystal particle has a blue color (Fe²⁺ is blue), and its surface is oxidized to produce a reddish brown color (Fe³⁺ is light yellow). If ferrous chloride is dissolved in a solvent, the oxidation changes Fe²⁺ into Fe³⁺, so that the solvent is changed to light yellow. With the electrons supplied by the first transparent conductive element 211, the light yellow Fe proximate to the electrochromic layer 3 of the first transparent conductive element 211 is reduced to the original blue Fe²⁺, and the whole electrochromic layer 23 is reduced to change the valence and its color from light yellow to blue, so to achieve a darker color effect. If the electrons in the first transparent conductive element 211 changes the electrochromic layer 23 from the blue Fe²⁺ to the light yellow Fe³⁺ by short circuit or a reverse voltage loading/unloading, the whole electrochromic layer 23 will change from blue to light yellow due to the oxidation and change of valence, so as to achieve the decoloration effect. The same applies to the electrochromic layer 23 and the first transparent conductive element 211, and the film thickness can be controlled to achieve the effect of changing the color from light yellow to transparent. Further, dimethyl sulfoxide or pH modifier in ferrous chloride can be adjusted to provide a blue, purple, pink or light yellow color display according to the difference of concentrations, potentials, solvent polarities, pH values, polar distance, and dielectric constants, wherein the pH modifier used in a flat display device can be methyl viologen, sodium diphenylamine sulfonate, N—N′-Diphenylbenzidine, N-phenyl-o-anthranilic acid, polyaniline, sodium hydroxide, potassium hydroxide, hydrochloric acid, or sulfuric acid.

The difference of this concept from a general inorganic electrochromic layer resides on that the inorganic electrochromic layer requires loading both ions and electrons into the crystal grids, and a relatively larger driving voltage, and thus the material may, have defects easily, and the lifespan is just ten to twenty thousand times only. On the other hand, the present invention simply requires a changing the valence of ions of the electrochromic material, not only requiring a small driving voltage, but avoiding defects of the material, and the lifespan can reach over thirty thousand times.

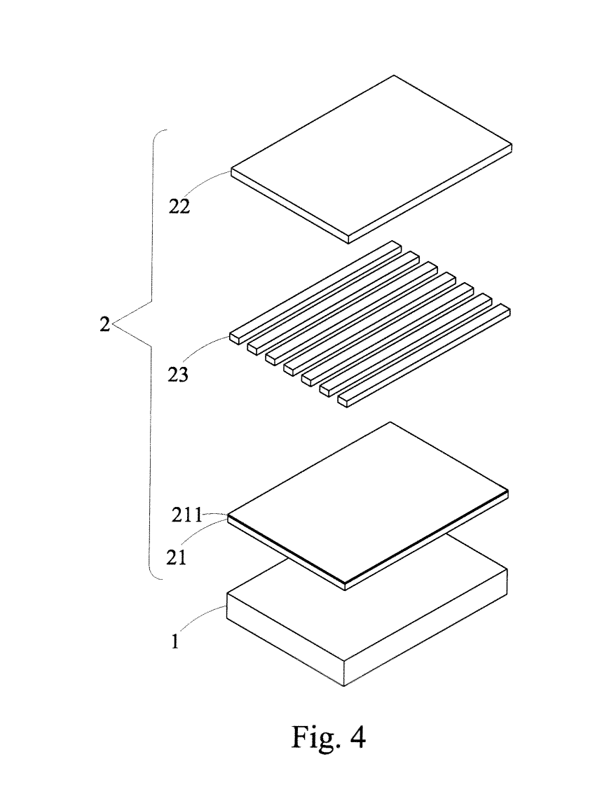

With reference to FIGS. 4 to 6 for an exploded view and first and second schematic views of actions in accordance with a second preferred embodiment of the present invention respectively, the aforementioned electrochromic unit 2 is used in the 3D display application, and the image display device applies the electrochromic unit 2 that is combined with an image display unit 1.

The image display unit 1 is provided for displaying a 2D image and a 3D image, and the displayed 3D image can be generated by a software, firmware or hardware technology. For example, software or firmware is used to convert a 2D image into an overlapped image including a left-eye image and aright-eye image, or a lenticular lens or barrier is used for dividing a 3D image into a left-eye image and aright-eye image, but the 3D image display technology is a prior art and not a technical characteristic of the present invention, and thus will not be described in details here. In addition, the display unit 1 can be one selected from the collection of a liquid crystal display (LCD), a plasma display panel (PDP), a surface conduction electron-emitter display (SED), a field emission display (FED), a vacuum fluorescent display (VFD), an organic light-emitting diode (OLED) and an E-paper.

The electrochromic unit 2 includes a first transparent substrate 21, a second transparent substrate 22 and a plurality of electrochromic layers 23, wherein at least one first transparent conductive element 211 is disposed on a surface of the first transparent substrate 21. To achieve better electrochromism and 3D shielding effect, the electrochromic layers 23 are arranged with an interval apart from each other and between the transparent substrates 21, 22.

The first and second transparent substrates 21, 22 and the first and second transparent conductive elements 211, 221 are made of the same material as described in the first preferred embodiment, and thus will not be described here again.

With the electrons supplied by the first transparent conductive element 211, the valence of ions of the electrochromic layers 23 is changed to produce a color change, and the electrochromic layers 23 are made of a material prepared by dissolving a transition element (of a copper subgroup (IB), a zinc subgroup (IIB), a scandium subgroup (IIIB), a titanium subgroup (IVB), a vanadium subgroup (VB), a chromium subgroup (VIB), a manganese subgroup (VIIB), an iron series (VIIIB) or an organic/inorganic derivative of an element or its oxide, sulfide, chloride, hydroxide of a platinum series (VIIIB of the fifth or sixth period), an alkali metal group (IA), an alkali earth metal group (IIA), an oxygen group (VIA), a nitrogen group (VA), a carbon group (VIA), a boron group (IIIA) into a solvent, and the elements or compounds of each group, subgroup or series are the same as those described in the first preferred embodiment, and thus will not be described here again.

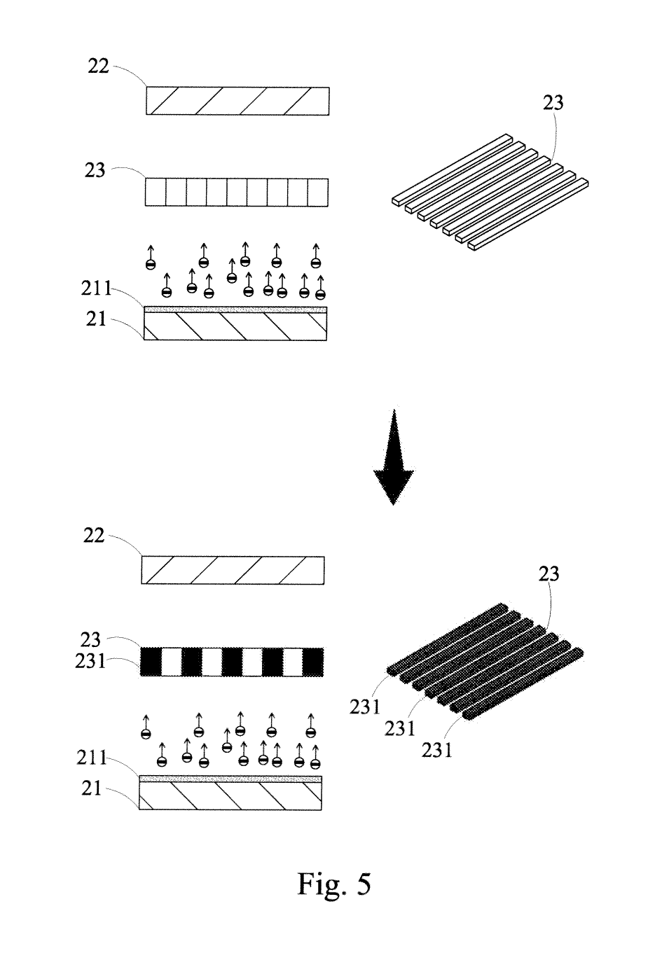

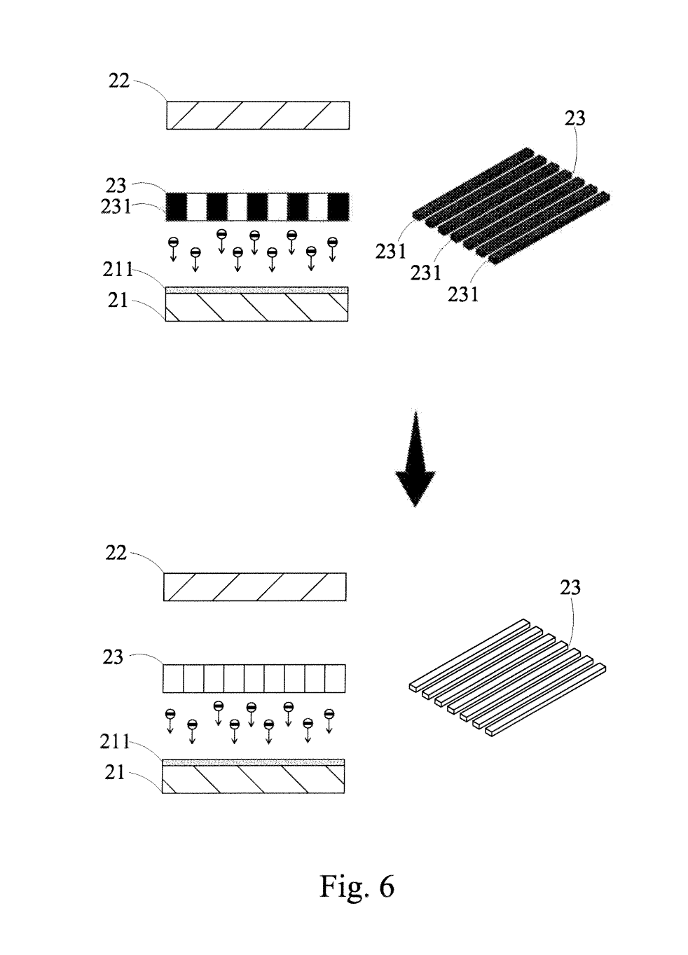

The electrochromic unit 2 is installed on an image projecting surface of the image display unit 1 corresponding to the image display unit 1, and after a multiple of images (divided into a left-eye image L and aright-eye image R) is processed and displayed by the image display unit 1, the electrochromic layers 23 are reduced by the supply of electrons from the first transparent conductive element 211 to change its color from a transparent or light color to a dark color (as shown in FIG. 5), and after electrons in the first transparent conductive element 211 are unloaded/loaded due to a short circuit or a reverse voltage, the electrochromic layers 23 are oxidized to change its color from the dark color to the transparent or light color again as shown in FIG. 6). The overlapped mage area can be eliminated by the light shield areas 231 formed after the electrochromic layers 23 are changed from the transparent or light color to the dark color, so that overlapped patterns will not be received by naked eyes.

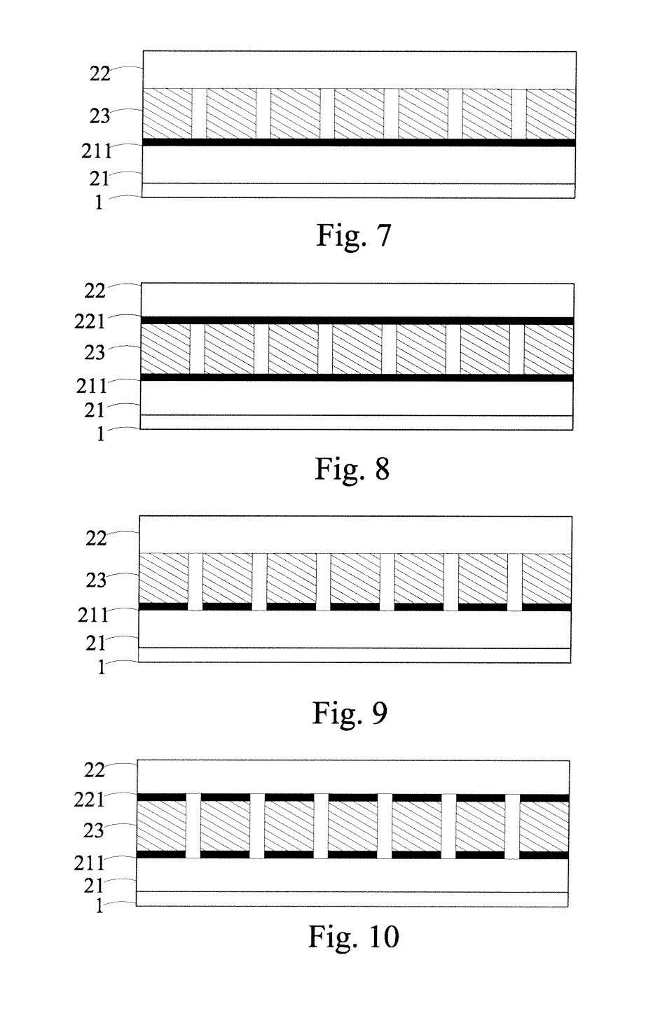

With reference to FIGS. 7 to 10 for first to fourth schematic views of a transparent conductive element in accordance with a second preferred embodiment of the present invention respectively, the first transparent substrate 21 includes at least one first transparent conductive element 211, or a the second transparent substrate 22 includes at least one second transparent conductive element 221; on a corresponding surface. Further, the first transparent conductive elements 211 can correspond to the electrochromic layers 23, and there is a plurality of first transparent conductive elements 211, but such structure is not limited to the arrangement of installing the conductive elements on a surface of an upper substrate, but the conductive elements can be installed on a surface of a middle or lower substrate. For example, the lower surface of the second transparent substrate 22 has a plurality of second transparent conductive elements 221 arranged with an interval apart from each other, or the first transparent conductive elements 211 and the second transparent conductive elements 221 are arranged with an interval apart from each other and on two corresponding surfaces of the first transparent substrate 21 and second transparent substrate 22 respectively.

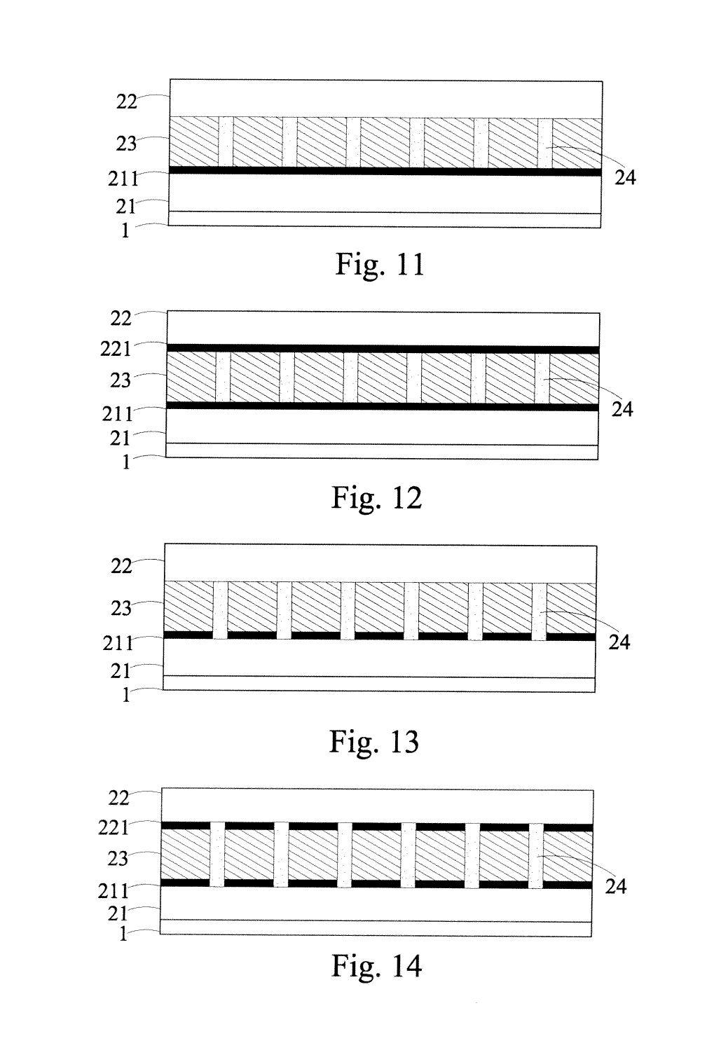

With reference o FIGS. 11 to 14 for first to fourth schematic views of a transparent conductive element in accordance with a third preferred embodiment of the present invention respectively, the difference of this preferred embodiment from the second preferred embodiment resides on that an isolating unit 24 is installed between two adjacent electrochromic layers 23, such that a plurality of spaces is formed between the transparent substrates 21, 22, and the electrochromic layers 23 are disposed in the plurality of spaces respectively, and a conductive polymer can be added to the electrochromic layers 23 by a screen printing method, but the electrochromic layer 23 of the present invention can be in a non-solid state such as in the form of liquid or gel. Therefore, the isolating unit 24 is provided for separating the electrochromic layers 23, or improving the structural strength and the using life. Preferably, the isolating unit 24 can be a photoresist. If the first transparent conductive elements 211 and the second transparent conductive elements 221 are arranged with an interval apart from each other, then each of the electrochromic layers 23 can correspond to any one of the first transparent conductive elements 211 individually, or correspond to any one of the second transparent conductive elements 221 individually, or correspond to one of the first transparent conductive elements 211 and one of the second transparent conductive elements 221 simultaneously.

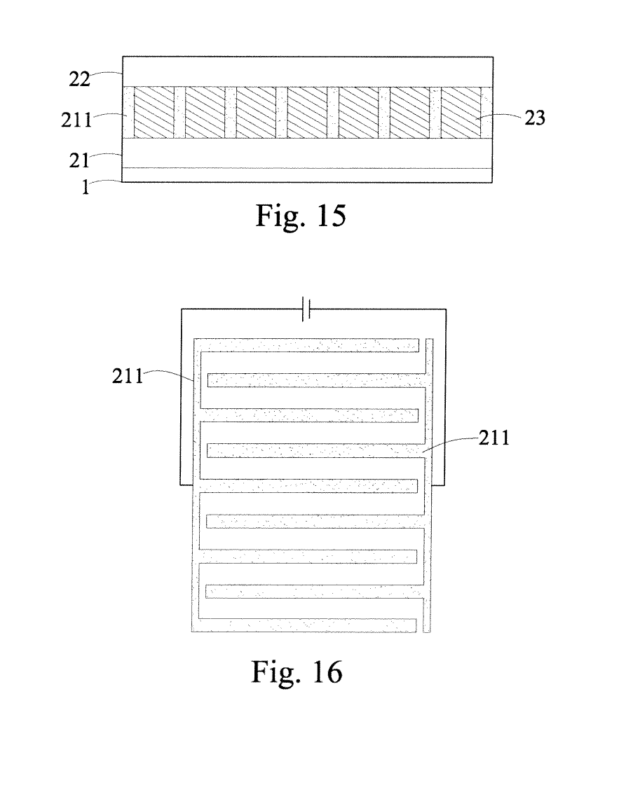

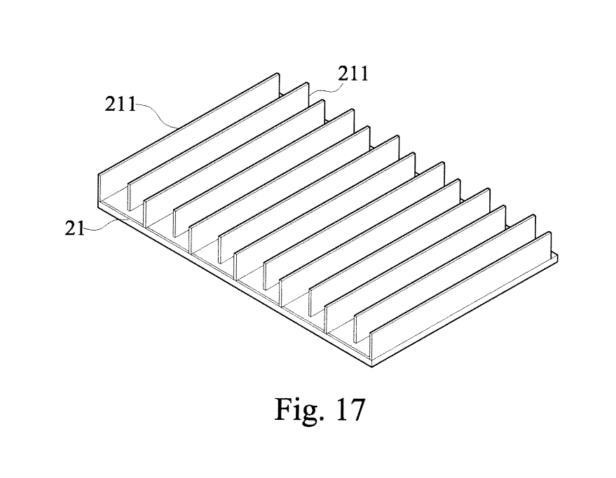

With reference to FIG. 15 for a cross-sectional view of a fourth preferred embodiment of the present invention, this preferred embodiment uses the transparent conductive element as an isolating unit, and the first transparent conductive elements 211 are divided into a plurality of spaces between the first transparent substrate 21 and the second transparent substrate 22, and the electrochromic layers 23 are disposed in the spaces. To simplify the circuit of supplying a voltage, the transparent conductive element can be installed according to a structural design as shown in FIG. 16, and FIG. 17 shows a perspective view of the structure, wherein high and low voltage are supplied alternately to the first transparent conductive elements 211, and the first transparent conductive elements 211 with different potentials are not in contact with each other, and the electrochromic layers 23 can be distributed in the space formed by the conductive elements 211 or coated by an insulator to package the electrochromic layer 23 into each space, as long as two adjacent transparent conductive elements are not connected with each other.

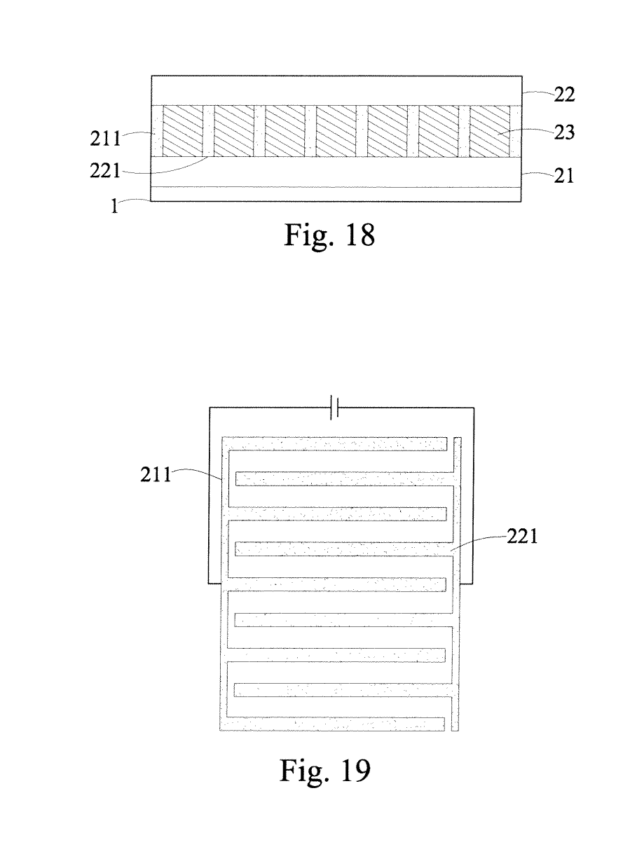

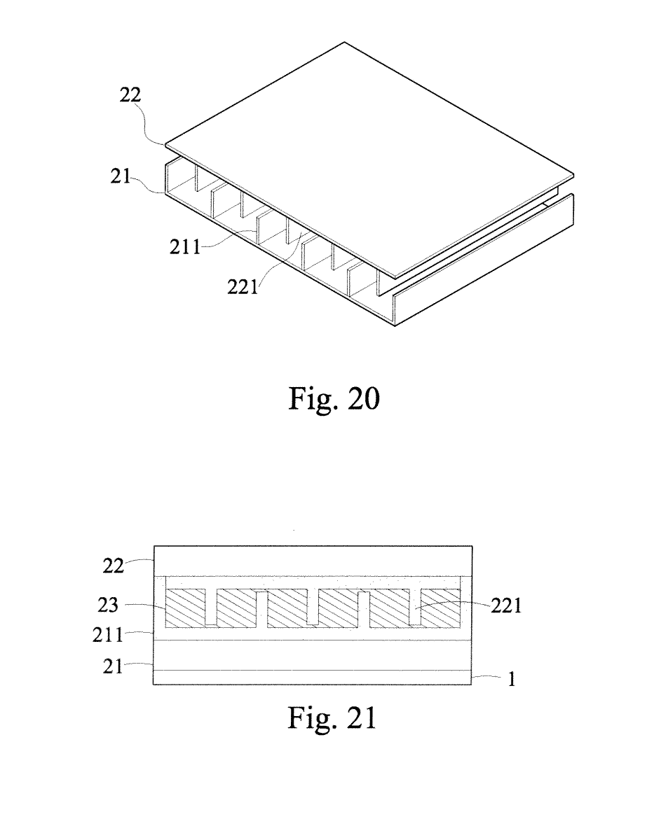

With reference to FIGS. 18 to 20 for a cross-sectional view, a top view and a schematic perspective view of a transparent conductive element in accordance with a fifth preferred embodiment of the present invention respectively, this preferred embodiment uses the first transparent conductive elements 211 and the second transparent conductive elements 221 as the isolating units, and also arranges the first transparent conductive elements 211 and the two transparent conductive elements 221 alternately with each other, and supplies high and low voltages with different potentials to the transparent conductive elements 211, 221, such that a voltage difference is formed in the space between each first transparent conductive element 211 and each second transparent conductive element 221 to provide electrons required for changing the color of the electrochromic layer 23.

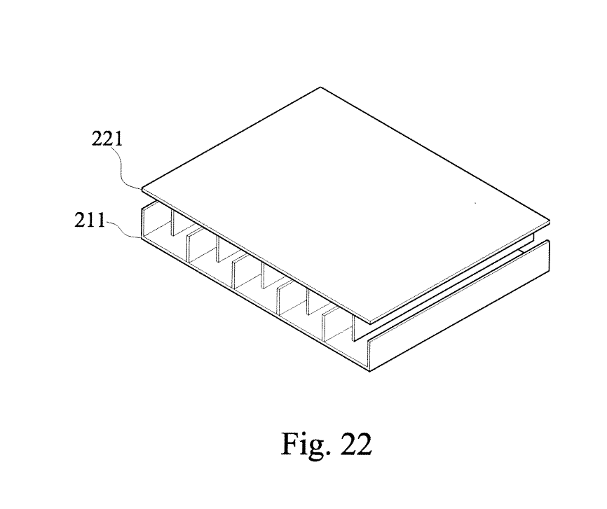

With reference to FIGS. 21 and 22 for a cross-sectional view and a schematic perspective view of a transparent conductive element in accordance with a sixth preferred embodiment of the present invention respectively, this preferred embodiment is similar to the fifth preferred embodiment that uses the first transparent conductive elements 211 and the second transparent conductive elements 221 as the isolating units, but the difference resides on that the first transparent conductive element 211 includes a plurality of containing slots formed directly thereon, and the second transparent conductive element 221 also includes a plurality of containing slots formed directly thereon in order to increases the contact area of the transparent conductive element and the electrochromic layer and the structural stability. When the first and second transparent conductive elements 211, 221 are combined one on top of the other, the transparent substrates 21, 22 are divided alternately into a plurality of spaces, and the electrochromic layers 23 are disposed in the spaces. It is noteworthy to point out that the first transparent conductive elements 211 and the second transparent conductive elements 221 are not in contact with each other as shown in the figures, and the upper second transparent conductive element 221 maintains a distance apart from the lower first transparent conductive element 211, and the lower second transparent conductive element are also installed in the same way.

In addition, a pH modifier is further added to all of the aforementioned electrochromic units 2 further and provided for controlling the color of the electrochromic layer 23, and the pH modifier can be sodium hydroxide (NaOH), potassium hydroxide (KOH), hydrochloric acid (HCl), sulfuric acid (H₂SO₄), methyl viologen (Methyl Viologen, C₁₂K₄N₂Cl₂), sodium diphenylamine sulfonate (C₁₂H₁₀NNaO₃S), N—N′-Diphenylbenzidine (C₂₀H₂₀N₂), N-phenyl-o-anthranilic acid (C₁₃H₁₁NO₂), and polyaniline.

In summation of the description above, the electrochromic unit and the display device using the electrochromic unit in accordance with the present invention complies with the patent application requirements, and thus is duly filed for patent application.

While the invention has been described by means of specific embodiments, numerous modifications and variations could be made thereto by those generally skilled in the art without departing from the scope and spirit of the invention set forth in the claims.

What is claimed is:

1. An electrochromic unit, comprising:
a first transparent substrate, having at least one first transparent conductive element formed on a surface of the first transparent substrate;
a second transparent substrate; and
an electrochromic layer, formed between the first transparent substrate and the second transparent substrate, for supplying electrons from the first transparent conductive element to change the valence of ions of a structure for a coloration of the structure.

2. The electrochromic unit of claim 1, wherein the transparent substrates are made of a material selected from the collection of plastic, polymer plastic and glass or a plastic polymer selected from the collection of resin, polyethylene terephthalate (PET), polycarbonate (PC), polyethylene (PE), polyvinyl chloride (PVC), polypropylene (PP), polystyrene (PS) and polymethylmethacrylate (PMMA).

3. The electrochromic unit of claim 1, wherein the first transparent conductive element is made of an impurity-doped oxide selected from the collection of indium tin oxide (ITO), indium zinc oxide (IZO), Al-doped ZnO (AZO) and antimony tin oxide (ATO).

4. The electrochromic unit of claim 1, wherein the first transparent conductive element is made of carbon nanotubes.

5. The electrochromic unit of claim 1, wherein the electrochromic layer is made of a material prepared by dissolving an organic/inorganic derivative selected from the collection of an oxide, a sulfide, a chloride, and a hydroxide of a transition element into a solvent.

6. The electrochromic unit of claim 5, wherein the transition element is one selected from the collection of a scandium subgroup (MB), a titanium subgroup (IVB), a vanadium subgroup (VB), a chromium subgroup (VIB), a manganese subgroup (VIIB), an iron series (VIII), a copper subgroup (IB), a zinc subgroup (IIB) and a platinum series (VIII).

7. The electrochromic unit of claim 1, wherein the electrochromic layer is made of a material prepared by dissolving an organic/inorganic derivative selected from the collection of an oxide, a sulfide, a chloride and a hydroxide of a halogen group (VIIA), an oxygen group (VIA), a nitrogen group (VA), a carbon group (IVA), a boron group (IIIA), an alkali earth metal group (IIA), or an alkali metal group (IA) into a solvent.

8. The electrochromic unit of claim 5, wherein the solvent is one selected from the collection of dimethyl sulfoxide (CH₃)₂SO, propylene carbonate (C₄H₆O₃) and water (H₂O).

9. The electrochromic unit of claim 7, wherein the solvent is one selected from the collection of dimethyl sulfoxide (CH₃)₂SO, propylene carbonate (C₄H₆O₃) and water (H₂O).

10. The electrochromic unit of claim 1, wherein the electrochromic layer further includes a pH modifier.

11. The electrochromic unit of claim 10, wherein the pH modifier is one selected from the collection of sodium hydroxide (NaOH), potassium hydroxide (KOH), hydrochloric acid (HO), sulfuric acid (H₂SO₄), methyl viologen (C₁₂H₁₄N₂Cl₂), sodium diphenylamine sulfonate (C₁₂H₁₀NNaO₃S), N—N′-Diphenylbenzidine (C₂₀H₂₀N₂), N-phenyl-o-anthranilic acid (C₁₃H₁₁NO₂) and polyaniline.

12. The electrochromic unit of claim 1, wherein the second transparent substrate further includes a second transparent conductive element disposed on a corresponding surface of the first transparent conductive element.

13. The electrochromic unit of claim 1, wherein the first transparent conductive elements are arranged with an interval apart from each other on the first transparent substrate, when there is a plurality of first transparent conductive elements.

14. The electrochromic unit of claim 13, wherein the second transparent substrate includes a plurality of second transparent conductive elements arranged with an interval apart from each other and disposed on corresponding surfaces of the first transparent conductive elements.

15. An image display device, comprising:
an image display unit, for displaying a 2D image and a 3D image;
an electrochromic unit, installed on a surface of the image display unit, and comprising:
a first transparent substrate, having at least one first transparent conductive elements disposed on a surface of the first transparent substrate; and
a plurality of electrochromic layers, arranged with an interval apart from each other and between the first transparent substrate and the second transparent substrate, for supplying electrons from the transparent conductive element to change the valence of ions of the electrochromic layers for a color change.

16. The image display device of claim 15, wherein the transparent substrates are made of a material selected from the collection of plastic, polymer plastic and glass, or a plastic polymer selected from the collection of resin, polyethylene terephthalate (PET), polycarbonate (PC), polyethylene (PE), polyvinyl chloride (PVC), polypropylene (PP), polystyrene (PS) and polymethylmethacrylate (PMMA).

17. The image display device of claim 15, wherein the first transparent conductive element is made of an impurity-doped oxide selected from the collection of indium tin oxide (ITO), indium zinc oxide (IZO). Al-doped ZnO (AZO), and antimony tin oxide (ATO).

18. The image display device of claim 15, wherein the first transparent conductive element is made of carbon nanotubes.

19. The image display device of claim 15, wherein the electrochromic layer is made of a material prepared by dissolving an oxide, sulfide, chloride or hydroxide of a transition element or an organic/inorganic derivative into a solvent.

20. The image display device of claim 19, wherein the transition element is one selected from the collection of a scandium subgroup (IIIB), a titanium subgroup (IVB), a vanadium subgroup (VB), a chromium subgroup (VIB), a manganese subgroup (VIIB), an iron series (VIII), a copper subgroup (IB), a zinc subgroup (IIB) and a platinum series (VIII).

21. The image display device of claim 15, wherein the electrochromic layer is made of a material prepared by dissolving an organic/inorganic derivative selected from the collection of an oxide, a sulfide, a chloride and a hydroxide of a halogen group (VIIA), an oxygen group (VIA), a nitrogen group (VA), a carbon group (IVA), a boron group (IIIA), an alkali earth metal group (IIA) or an alkali metal group (IA) into a solvent.

22. The image display device of claim 19, wherein the solvent is one selected from the collection of dimethyl sulfoxide (CH₃)₂SO, propylene carbonate (C₄H₆O₃) and water (H₂O).

23. The image display device of claim 21, wherein the solvent is one selected from the collection of dimethyl sulfoxide (CH₃)₂SO, propylene carbonate (C₄H₆O₃) and water (H₂O).

24. The image display device of claim 15, wherein the electrochromic layer further includes a pH modifier.

25. The image display device of claim 24, wherein the pH modifier is one selected from the collection of sodium hydroxide (NaOH), potassium hydroxide (KOH), hydrochloric acid (HCl), sulfuric acid (H₂SO₄), methyl viologen (Methyl Viologen, C₁₂H₁₄N₂Cl₂), sodium diphenylamine sulfonate (C₁₂H₁₀NNaO₃S), N—N′-Diphenylbenzidine (C₂₀H₂₀N₂), N-phenyl-o-anthranilic acid (C₁₃H₁₁NO₂) and polyaniline.

26. The image display device of claim 15, wherein the second transparent substrate further includes at least one second transparent conductive element disposed on a surface of second transparent substrate corresponding to the first transparent conductive element.

27. The image display device of claim 15, wherein the first transparent conductive elements are arranged with an interval apart from each other and disposed on the first transparent substrate, when there is a plurality of first transparent conductive elements.

28. The image display device of claim 27, wherein the second transparent substrate includes a plurality of second transparent conductive elements arranged with an interval apart from each other and disposed on a surface of second transparent substrate corresponding to the first transparent conductive element.

29. The image display device of claim 15, wherein the first and the second transparent substrates further comprise a plurality of isolating unit arranged with an interval apart from each other respectively, and the electrochromic layers are disposed between isolating units.

30. The image display device of claim 26, wherein the first and the second transparent substrates further comprise a plurality of isolating unit arranged with an interval apart from each other respectively, and the electrochromic layers are disposed between isolating units.

31. The image display device of claim 29, wherein the isolating units are photoresists.

32. The image display device of claim 30, wherein the isolating units are photoresists.

33. The image display device of claim 15, wherein the first transparent conductive elements are arranged with an interval apart from each other and disposed between the electrochromic layers, when there is a plurality of first transparent conductive elements.

34. The image display device of claim 26, wherein the first transparent conductive element and the second transparent conductive element further include a plurality of containing slots, and the electrochromic layers are formed in the containing slots.

35. The image display device of claim 26, wherein the plurality of first transparent conductive elements and the plurality of second transparent conductive elements are arranged sequentially between the first transparent substrates and the second transparent substrates repestively, when there are a plurality of first transparent conductive elements and a plurality of second transparent conductive elements, and the electrochromic layers are formed between one of the first transparent conductive elements and one of the second transparent conductive elements.

36. The image display device of claim 15, wherein the electrochromic layers are further mixed with a conductive polymer material.

37. The image display device of claim 36, wherein the electrochromic layers are formed on a surface of the first transparent substrate by a screen printing method.

38. An image display device, comprising:
an image display unit, for displaying a 2D image and a 3D image;
an electrochromic unit, installed on a surface of the image display unit, and comprising:
a first transparent substrate, having a plurality of first transparent conductive elements arranged with an interval apart from each other on a surface of the first transparent substrate;
a second transparent substrate;
a plurality of electrochromic layers, disposed between the first transparent conductive elements and the second transparent substrate, for supplying electrons from the transparent conductive element to the electrochromic layers to change the valence of ions of the electrochromic layers for a color change; and
a plurality of isolating units, installed between the electrochromic layers.

39. The image display device of claim 38, wherein the first and second transparent substrates are made of a material selected from the collection of plastic, polymer plastic and glass, or a plastic polymer selected from the collection of resin, polyethylene terephthalate (PET), polycarbonate (PC), polyethylene (PE), polyvinyl chloride (PVC), polypropylene (PP), polystyrene (PS) and polymethylmethacrylate (PMMA).

40. The image display device of claim 38, wherein the transparent conductive elements are made of an impurity-doped oxide selected from the collection of indium tin oxide (ITO), indium zinc oxide (IZO), Al-doped ZnO (AZO), and antimony tin oxide (ATO).

41. The image display device of claim 38, wherein the first transparent conductive elements are made of carbon nanotubes.

42. The image display device of claim 38, wherein the electrochromic layer is made of a material prepared by dissolving an organic/inorganic derivative selected from the collection of an oxide, a sulfide, a chloride and a hydroxide of a transition element into a solvent.

43. The image display device of claim 42, wherein the transition element is one selected from the collection of a scandium subgroup (IIIB), a titanium subgroup (IVB), a vanadium subgroup (VB), a chromium subgroup (VIB), a manganese subgroup (VIIB), an iron series (VIII), a copper subgroup (IB), a zinc subgroup (IIB) and a platinum series (VIII).

44. The image display device of claim 38, wherein the electrochromic layer is made of a material prepared by dissolving an organic/inorganic derivative selected from the collection of an oxide, a sulfide, a chloride and a hydroxide of a halogen group (VIIA), an oxygen group (VIA), a nitrogen group (VA), a carbon group (IVA), a boron group (IIIA), an alkali earth metal group (HA), or an alkali metal group (IA) into a solvent.

45. The image display device of claim 42, wherein the solvent is one selected from the collection of dimethyl sulfoxide (CH₃)₂SO, propylene carbonate (C₄H₆O₃) and water (H₂O).

46. The image display device of claim 44, wherein the solvent is one selected from the collection of dimethyl sulfoxide (CH₃)₂SO, propylene carbonate (C₄H₆O₃) and water (H₂O).

47. The image display device of claim 38, wherein the electrochromic layer further includes a pH modifier.

48. The image display device of claim 47, wherein the pH modifier is one selected from the collection of sodium hydroxide (NaOH), potassium hydroxide (KOH), hydrochloric acid (HCl), sulfuric acid (H₂SO₄), methyl viologen(C₁₂H₁₄N₂Cl₂), sodium diphenylamine sulfonate (C₁₂H₁₀NNaO₃S), N—N′-Diphenylbenzidine (C₂₀H₂₀N₂), N-phenyl-o-anthranilic acid (C₁₃H₁₁NO₂) and polyaniline.

49. The image display device of claim 38, wherein the isolating unit is a photoresist.

50. The image display device of claim 38, wherein the electrochromic layers are further mixed with a conductive polymer material.

51. The image display device of claim 50, wherein the electrochromic layers are formed on a surface of the first transparent substrate by a screen printing method.

52. The image display device of claim 38, wherein the second transparent substrate further comprises a plurality of second transparent conductive elements arranged with an interval apart from each other and disposed on a surface of the second transparent substrate corresponding to the first transparent conductive elements.
